(19) United States
(12) Patent Application Publication
(10) Pub. No.: US 2021/0201066 A1
(43) Pub. Date: Jul. 1, 2021

(54) SYSTEMS AND METHODS FOR DISPLAYING REGION OF INTEREST ON MULTI-PLANE RECONSTRUCTION IMAGE

(71) Applicant: SHANGHAI UNITED IMAGING INTELLIGENCE CO., LTD., Shanghai (CN)

(72) Inventors: Ruihuan CUI, Shanghai (CN); Hong SHEN, Shanghai (CN)

(73) Assignee: SHANGHAI UNITED IMAGING INTELLIGENCE CO., LTD., Shanghai (CN)

(21) Appl. No.: 17/137,368

(22) Filed: Dec. 30, 2020

(30) Foreign Application Priority Data
Dec. 30, 2019 (CN) 201911399531.1

(51) Int. Cl. G06K 9/32; G06K 9/62; G06T 7/00; G06T 7/11; G06N 3/04

(52) U.S. Cl. CPC G06K 9/3233; G06K 9/6256; G06T 7/0012; G06T 2207/10088; G06N 3/04; G06T 2207/10081; G06T 7/11

(57) ABSTRACT

A method for image processing may be provided. The method may include obtaining a 3D image of a subject and an ROI within the subject. The method may also include generating a 3D segmentation image relating to the ROI of the subject based on the 3D image. The method may also include selecting an MPR plane from the 3D image. The method may further include determining a target 2D image of the MPR plane based on the 3D image and the 3D segmentation image. The target 2D image of the MPR plane may include a bounding box annotating the ROI on the MPR plane.

### CROSS-REFERENCE TO RELATED APPLICATIONS

This application claims priority to Chinese Patent Application No. 201911399531.1, filed on Dec. 30, 2019, the contents of which are hereby incorporated by reference.

### TECHNICAL FIELD

The present disclosure generally relates to image processing, and more particularly, methods and systems for displaying a region of interest (ROI) on a multi-planar reconstruction (MPR) image by image processing.

### BACKGROUND

Medical imaging techniques, such as a magnetic resonance imaging (MRI) technique, a computed tomography (CT) imaging technique, or the like, have been widely used for disease diagnosis and treatment. Multi-planar reconstruction (MPR) is an image reconstruction technique used to generate two-dimensional (2D) image data of a target plane (e.g., a sagittal plane, a coronal plane, an axial plane, or any other oblique plane) of a subject based on three-dimensional (3D) image data of the subject or 2D image data of another plane of the subject acquired by a medical imaging technique. It is desirable to provide systems and methods for image processing in MPR.

### SUMMARY

According to an aspect of the present disclosure, a system for image processing may be provided. The system may include at least one storage device and at least one processor configured to communicate with the at least one storage device. The at least one storage device may include a set of instructions. When the at least one processor execute the set of instructions, the at least one processor may be directed to cause the system to perform one or more of the following operations. The system may obtain a 3D image of a subject and an ROI within the subject. The system may generate a 3D segmentation image relating to the ROI of the subject based on the 3D image. The system may also select an MPR plane from the 3D image. The system may further determine a target 2D image of the MPR plane based on the 3D image and the 3D segmentation image. The target 2D image of the MPR plane may include a bounding box annotating the ROI on the MPR plane.

In some embodiments, to select an MPR plane from the 3D image, the system may determine a central point and a normal vector of the MPR plane from the 3D image. The system may further determine the MPR plane based on the central point and the normal vector of the MPR plane.

In some embodiments, to determine a target 2D image of the MPR plane based on the 3D image and 3D segmentation image, the system may determine an initial 2D image of the MPR plane based on the 3D image. The initial 2D image may include a pixel value of each physical point on the MPR plane. The system may also determine position information of the bounding box based on the 3D segmentation image. The system may further generate the target 2D image of the MPR plane based on the initial 2D image and the position information of the bounding box.

In some embodiments, to the determine an initial 2D image of the MPR plane based on the 3D image, the system may perform one or more of the following operations. For each physical point on the MPR plane, the system may identify a first voxel corresponding to the physical point from the 3D image. The system may also determine a first pixel value of the physical point based on the 3D image and the first voxel. The system may generate the initial 2D image based on the first pixel value of each physical point.

In some embodiments, to determine position information of the bounding box based on the 3D segmentation image, the system may determine a 2D segmentation image of the ROI corresponding to the MPR plane based on the 3D segmentation image and the MPR plane. The system may further determine the position information of the bounding box of the ROI based on the 2D segmentation image.

In some embodiments, to determine a 2D segmentation image of the ROI corresponding to the MPR plane based on the 3D segmentation image and the MPR plane, the system may perform one or more of the following operations. For each physical point on the MPR plane, the system may identify a second voxel corresponding to the physical point from the 3D segmentation image. The system may also determine a second pixel value of the physical point based on the 3D segmentation image and the second voxel. The system may further generate the 2D segmentation image based on the second pixel value of each physical point.

In some embodiments, the MPR plane may correspond to a coordinate system including a first coordinate axis and a second coordinate axis. To determine the position information of the bounding box of the ROI based on the 2D segmentation image, the system may determine a first maximum value and a first minimum value of the ROI on the first coordinate axis, and a second maximum value and a second minimum value of the ROI on the second coordinate axis based on the 2D segmentation image. The system may further determine the position information of the bounding box based on the first maximum value, the first minimum value, the second maximum value, and the second minimum value.

In some embodiments, the ROI may include multiple sub-ROIs. The at least one processor may be directed to cause the system to perform one or more of the following operations. The system may select one or more target sub-ROIs from the multiple sub-rois. The bounding box may annotate the one or more target sub-ROIs on the MPR plane.

In some embodiments, to generate a 3D segmentation image relating to the ROI of the subject based on the 3D image, the system may generate the 3D segmentation image by processing the 3D image using an ROI segmentation model.

In some embodiments, to generate the ROI segmentation model, the system may obtain at least one training sample each of which includes a sample 3D image of a sample subject and a ground truth 3D segmentation image of a sample ROI of the sample subject. The system may further generate the ROI segmentation model by training a preliminary model using the at least one training sample.

In some embodiments, to obtain at least one training sample, the system may obtain at least one initial training sample. The system may further generate the at least one training sample by preprocessing the at least one initial training sample.

According to another aspect of the present disclosure, a method for image processing may be provided. The method may include obtaining a 3D image of a subject and an ROI within the subject. The method may also include generating a 3D segmentation image relating to the ROI of the subject based on the 3D image. The method may also include selecting an MPR plane from the 3D image. The method may further include determining a target 2D image of the MPR plane based on the 3D image and the 3D segmentation image. The target 2D image of the MPR plane may include a bounding box annotating the ROI on the MPR plane.

According to yet another aspect of the present disclosure, a non-transitory computer readable medium may be provided. The non-transitory computer readable may include a set of instructions for image processing. When executed by at least one processor of a computing device, the set of instructions may cause the computing device to perform a method. The method may include obtaining a 3D image of a subject and an ROI within the subject. The method may also include generating a 3D segmentation image relating to the ROI of the subject based on the 3D image. The method may also include selecting an MPR plane from the 3D image. The method may further include determining a target 2D image of the MPR plane based on the 3D image and the 3D segmentation image. The target 2D image of the MPR plane may include a bounding box annotating the ROI on the MPR plane.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary imaging system according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device according to some embodiments of the present disclosure;

FIGS. 4A and 4B are block diagrams illustrating exemplary processing devices according to some embodiments of the present disclosure;

FIG. 5 is a flowchart illustrating an exemplary process for generating a target 2D image of an MPR plane of a subject according to some embodiments of the present disclosure;

FIG. 6 is a flowchart illustrating an exemplary process for generating a target 2D image of an MPR plane according to some embodiments of the present disclosure;

FIG. 7 is a flowchart illustrating an exemplary process for determining position information of a bounding box of an ROI according to some embodiments of the present disclosure;

FIG. 8 is a flowchart illustrating an exemplary process for generating an ROI segmentation model according to some embodiments of the present disclosure;

FIG. 9 is a schematic diagram illustrating an exemplary MPR plane according to some embodiments of the present disclosure;

FIG. 10 is a schematic diagram illustrating an exemplary target 2D image of an MPR plane according to some embodiments of the present disclosure;

FIG. 11A is a schematic diagram illustrating an exemplary preliminary model according to some embodiments of the present disclosure; and

FIG. 11B is a schematic diagram illustrating an exemplary residual block according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, sections or assembly of different levels in ascending order. However, the terms may be displaced by another expression if they achieve the same purpose.

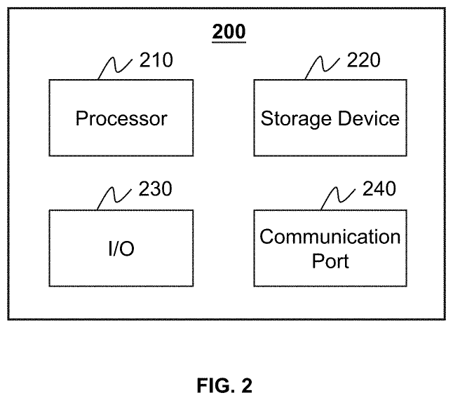

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices (e.g., processor 210 as illustrated in FIG. 2) may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module, or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items. The term “image” in the present disclosure is used to collectively refer to image data (e.g., scan data, projection data) and/or images of various forms, including a two-dimensional (2D) image, a three-dimensional (3D) image, a four-dimensional (4D), etc. The term “pixel” and “voxel” in the present disclosure are used interchangeably to refer to an element of an image. An anatomical structure shown in an image of a subject may correspond to an actual anatomical structure existing in or on the subject's body. The term “segmenting an anatomical structure” or “identifying an anatomical structure” in an image of a subject may refer to segmenting or identifying a portion in the image that corresponds to an actual anatomical structure existing in or on the subject's body. The term “region,” “location,” and “area” in the present disclosure may refer to a location of an anatomical structure shown in the image or an actual location of the anatomical structure existing in or on the subject's body, since the image may indicate the actual location of a certain anatomical structure existing in or on the subject's body.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

Provided herein are systems and methods for non-invasive biomedical imaging, such as for disease diagnostic or research purposes. In some embodiments, the systems may include a single modality imaging system and/or a multi-modality imaging system. The single modality imaging system may include, for example, an ultrasound imaging system, an X-ray imaging system, an computed tomography (CT) system, a magnetic resonance imaging (MRI) system, an ultrasonography system, a positron emission tomography (PET) system, an optical coherence tomography (OCT) imaging system, an ultrasound (US) imaging system, an intravascular ultrasound (IVUS) imaging system, a near-infrared spectroscopy (NIRS) imaging system, a far-infrared (FIR) imaging system, or the like, or any combination thereof. The multi-modality imaging system may include, for example, an X-ray imaging-magnetic resonance imaging (X-ray-MRI) system, a positron emission tomography-X-ray imaging (PET-X-ray) system, a single-photon emission computed tomography-magnetic resonance imaging (SPECT-MRI) system, a positron emission tomography-computed tomography (PET-CT) system, a C-arm system, a digital subtraction angiography-magnetic resonance imaging (DSA-MRI) system, etc. It should be noted that the imaging system described below is merely provided for illustration purposes, and not intended to limit the scope of the present disclosure.

The term “imaging modality” or “modality” as used herein broadly refers to an imaging method or technology that gathers, generates, processes, and/or analyzes imaging information of a subject. The subject may include a biological subject and/or a non-biological subject. The biological subject may be a human being, an animal, a plant, or a portion thereof (e.g., a heart, a breast, etc.). In some embodiments, the subject may be a man-made composition of organic and/or inorganic matters that are with or without life.

In some occasions, 3D image data of a subject or 2D image data of a plane of the subject may be acquired using a medical imaging technique, and 2D image data of another MPR plane of the subject may need to be generated based on the 3D image data or the 2D image data. For example, in order to inspect an ROI on an MPR plane of the subject, a target 2D image indicating the ROI on the MPR plane may need to be generated and displayed to a user for disease diagnosis and/or treatment. Conventionally, a user (e.g., a doctor) may need to identify an ROI on image data of the MPR plane according to experience. However, such identification of the ROI may be inefficient and/or susceptible to human errors or subjectivity.

Recently, machine learning algorithms have been used to determine an ROI on an MPR plane of a subject. Specifically, a 3D bounding box of the ROI of the subject may be determined based on a 3D image of the subject using a machine learning algorithm. The ROI on the MPR plane of the subject may be determined by extracting a 2D bounding box corresponding to the ROI on the MPR plane from the 3D bounding box. However, the 2D bounding box determined by conventional approaches usually has a limited accuracy, for example, has a size larger than an actual size of the ROI, or has an irregular shape, etc. Thus, it may be desirable to provide systems and methods for automatically and accurately generating a target 2D image that indicates an ROI on an MPR plane of a subject. The terms “automatic” and “automated” are used interchangeably referring to methods and systems that analyze information and generates results with little or no direct human intervention.

An aspect of the present disclosure relates to systems and methods for generating a target 2D image indicating an ROI on an MPR plane of a subject. The systems may obtain a 3D image of the subject. The systems may also generate a 3D segmentation image of an ROI of the subject based on the 3D image. The systems may further select an MPR plane from the 3D image, and determine the target 2D image of the MPR plane based on the 3D image and the 3D segmentation image. The target 2D image of the MPR plane may include a bounding box annotating the ROI on the MPR plane. Compared with the conventional approaches, the systems and methods of the present disclosure may be fully or partially automated, and improve the accuracy and/or efficiency of the generation of the target 2D image.

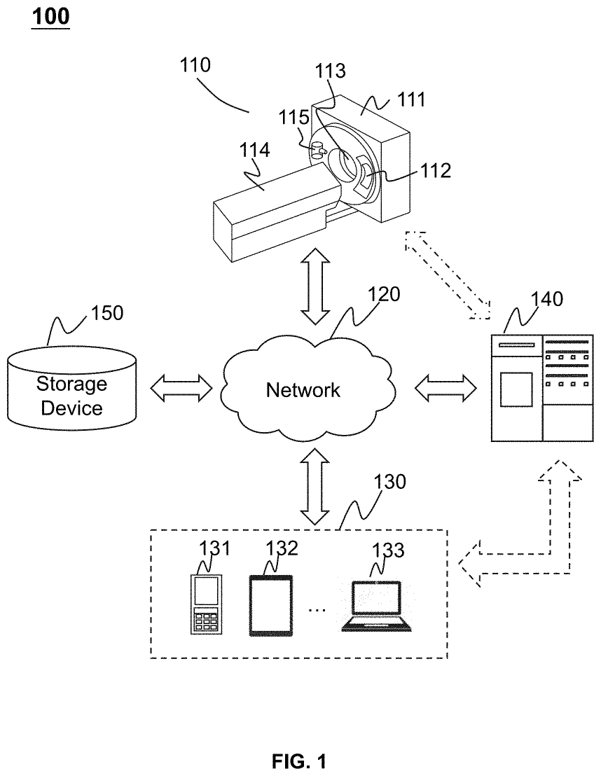

FIG. 1 is a schematic diagram illustrating an exemplary imaging system 100 according to some embodiments of the present disclosure. As shown, the imaging system 100 may include an imaging device 110, a network 120, one or more terminals 130, a processing device 140, and a storage device 150. In some embodiments, the imaging device 110, the terminal(s) 130, the processing device 140, and/or the storage device 150 may be connected to and/or communicate with each other via a wireless connection (e.g., the network 120), a wired connection, or a combination thereof. The connection between the components of the imaging system 100 may be variable. Merely by way of example, the imaging device 110 may be connected to the processing device 140 through the network 120, as illustrated in FIG. 1. As another example, the imaging device 110 may be connected to the processing device 140 directly or through the network 120. As a further example, the storage device 150 may be connected to the processing device 140 through the network 120 or directly.

The imaging device 110 may generate or provide image data related to a subject via scanning the subject. In some embodiments, the subject may include a biological subject and/or a non-biological subject. For example, the subject may include a specific portion of a body, such as a heart, a breast, or the like. In some embodiments, the imaging device 110 may include a single-modality scanner (e.g., an MRI device, a CT scanner) and/or multi-modality scanner (e.g., a PET-MRI scanner) as described elsewhere in this disclosure. In some embodiments, the image data relating to the subject may include projection data, one or more images of the subject, etc. The projection data may include raw data generated by the imaging device 110 by scanning the subject and/or data generated by a forward projection on an image of the subject.

In some embodiments, the imaging device 110 may include a gantry 111, a detector 112, a detection region 113, a scanning table 114, and a radioactive scanning source 115. The gantry 111 may support the detector 112 and the radioactive scanning source 115. The subject may be placed on the scanning table 114 to be scanned. The radioactive scanning source 115 may emit radioactive rays to the subject. The radiation may include a particle ray, a photon ray, or the like, or a combination thereof. In some embodiments, the radiation may include a plurality of radiation particles (e.g., neutrons, protons, electrons, p-mesons, heavy ions), a plurality of radiation photons (e.g., X-ray, a g-ray, ultraviolet, laser), or the like, or a combination thereof. The detector 112 may detect radiations and/or radiation events (e.g., gamma photons) emitted from the detection region 113. In some embodiments, the detector 112 may include a plurality of detector units. The detector units may include a scintillation detector (e.g., a cesium iodide detector) or a gas detector. The detector unit may be a single-row detector or a multi-rows detector.

The network 120 may include any suitable network that can facilitate the exchange of information and/or data for the imaging system 100. In some embodiments, one or more components of the imaging system 100 (e.g., the imaging device 110, the processing device 140, the storage device 150, the terminal(s) 130) may communicate information and/or data with one or more other components of the imaging system 100 via the network 120. For example, the processing device 140 may obtain image data from the imaging device 110 via the network 120. As another example, the processing device 140 may obtain user instruction(s) from the terminal(s) 130 via the network 120.

The network 120 may be or include a public network (e.g., the Internet), a private network (e.g., a local area network (LAN)), a wired network, a wireless network (e.g., an 802.11 network, a Wi-Fi network), a frame relay network, a virtual private network (VPN), a satellite network, a telephone network, routers, hubs, switches, server computers, and/or any combination thereof. For example, the network 120 may include a cable network, a wireline network, a fiber-optic network, a telecommunications network, an intranet, a wireless local area network (WLAN), a metropolitan area network (MAN), a public telephone switched network (PSTN), a Bluetooth™ network, a ZigBee™ network, a near field communication (NFC) network, or the like, or any combination thereof. In some embodiments, the network 120 may include one or more network access points. For example, the network 120 may include wired and/or wireless network access points such as base stations and/or internet exchange points through which one or more components of the imaging system 100 may be connected to the network 120 to exchange data and/or information.

The terminal(s) 130 may be connected to and/or communicate with the imaging device 110, the processing device 140, and/or the storage device 150. For example, the terminal(s) 130 may receive a user instruction to generate a target 2D image of an MPR plane of a subject. The target 2D image of the MPR plane may include a bounding box annotating an ROI of the subject on the MPR plane. As another example, the terminal(s) 130 may display the target 2D image of the MPR plane generated by the processing device 140. In some embodiments, the terminal(s) 130 may include a mobile device 131, a tablet computer 132, a laptop computer 133, or the like, or any combination thereof. For example, the mobile device 131 may include a mobile phone, a personal digital assistant (PDA), a gaming device, a navigation device, a point of sale (POS) device, a laptop, a tablet computer, a desktop, or the like, or any combination thereof. In some embodiments, the terminal(s) 130 may include an input device, an output device, etc. In some embodiments, the terminal(s) 130 may be part of the processing device 140.

The processing device 140 may process data and/or information obtained from the imaging device 110, the storage device 150, the terminal(s) 130, or other components of the imaging system 100. In some embodiments, the processing device 140 may be a single server or a server group. The server group may be centralized or distributed. For example, the processing device 140 may generate one or more trained models that can be used in image processing. As another example, the processing device 140 may apply the trained model(s) in image processing. In some embodiments, the trained model(s) may be generated by a processing device, while the application of the trained model(s) may be performed on a different processing device. In some embodiments, the trained model(s) may be generated by a processing device of a system different from the imaging system 100 or a server different from the processing device 140 on which the application of the model(s) is performed. For instance, the trained model(s) may be generated by a first system of a vendor who provides and/or maintains such trained model(s), while the image processing may be performed on a second system of a client of the vendor. In some embodiments, the application of the trained model(s) may be performed online in response to a request for image processing. In some embodiments, the trained model(s) may be generated offline.

In some embodiments, the trained model(s) may be generated and/or updated (or maintained) by, e.g., the manufacturer of the imaging device 110 or a vendor. For instance, the manufacturer or the vendor may load the trained model(s) into the imaging system 100 or a portion thereof (e.g., the processing device 140) before or during the installation of the imaging device 110 and/or the processing device 140, and maintain or update the trained model(s) from time to time (periodically or not). The maintenance or update may be achieved by installing a program stored on a storage device (e.g., a compact disc, a USB drive, etc.) or retrieved from an external source (e.g., a server maintained by the manufacturer or vendor) via the network 120. The program may include a new model (e.g., a new model(s)) or a portion of a model that substitutes or supplements a corresponding portion of the trained model(s).

In some embodiments, the processing device 140 may be local to or remote from the imaging system 100. For example, the processing device 140 may access information and/or data from the imaging device 110, the storage device 150, and/or the terminal(s) 130 via the network 120. As another example, the processing device 140 may be directly connected to the imaging device 110, the terminal(s) 130, and/or the storage device 150 to access information and/or data. In some embodiments, the processing device 140 may be implemented on a cloud platform. For example, the cloud platform may include a private cloud, a public cloud, a hybrid cloud, a community cloud, a distributed cloud, an inter-cloud, a multi-cloud, or the like, or a combination thereof. In some embodiments, the processing device 140 may be implemented by a computing device 200 having one or more components as described in connection with FIG. 2.

In some embodiments, the processing device 140 may include one or more processors (e.g., single-core processor(s) or multi-core processor(s)). Merely by way of example, the processing device 140 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The storage device 150 may store data, instructions, and/or any other information. In some embodiments, the storage device 150 may store data obtained from the processing device 140, the terminal(s) 130, and/or the imaging device 110. For example, the storage device 150 may store image data collected by the imaging device 110. As another example, the storage device 130 may store one or more images (e.g., a 3D image of a subject, a 3D segmentation image of an ROI of a subject, etc.). As further another example, the storage device 130 may store a target 2D image of an MPR plane generated by the processing device 140. In some embodiments, the storage device 150 may store data and/or instructions that the processing device 140 may execute or use to perform exemplary methods described in the present disclosure. For example, the storage device 150 may store data and/or instructions that the processing device 140 may execute or use for image processing.

In some embodiments, the storage device 150 may include a mass storage device, a removable storage device, a volatile read-and-write memory, a read-only memory (ROM), or the like, or any combination thereof. Exemplary mass storage devices may include a magnetic disk, an optical disk, a solid-state drive, etc. Exemplary removable storage devices may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 150 may be implemented on a cloud platform as described elsewhere in the disclosure.

In some embodiments, the storage device 150 may be connected to the network 120 to communicate with one or more other components of the imaging system 100 (e.g., the processing device 140, the terminal(s) 130). One or more components of the imaging system 100 may access the data or instructions stored in the storage device 150 via the network 120. In some embodiments, the storage device 150 may be part of the processing device 140.

It should be noted that the above description of the imaging system 100 is intended to be illustrative, and not to limit the scope of the present disclosure. Many alternatives, modifications, and variations will be apparent to those skilled in the art. The features, structures, methods, and other characteristics of the exemplary embodiments described herein may be combined in various ways to obtain additional and/or alternative exemplary embodiments. For example, the imaging system 100 may include one or more additional components. Additionally or alternatively, one or more components of the imaging system 100 described above may be omitted. As another example, two or more components of the imaging system 100 may be integrated into a single component.

FIG. 2 is a schematic diagram illustrating exemplary hardware and/or software components of a computing device 200 according to some embodiments of the present disclosure. The computing device 200 may be used to implement any component of the imaging system 100 as described herein. For example, the processing device 140 and/or the terminal(s) 130 may be implemented on the computing device 200, respectively, via its hardware, software program, firmware, or a combination thereof. Although only one such computing device is shown, for convenience, the computer functions relating to the imaging system 100 as described herein may be implemented in a distributed fashion on a number of similar platforms, to distribute the processing load. As illustrated in FIG. 2, the computing device 200 may include a processor 210, a storage device 220, an input/output (I/O) 230, and a communication port 240.

The processor 210 may execute computer instructions (e.g., program code) and perform functions of the processing device 140 in accordance with techniques described herein. The computer instructions may include, for example, routines, programs, objects, components, data structures, procedures, modules, and functions, which perform particular functions described herein. For example, the processor 210 may process image data obtained from the imaging device 110, the terminal(s) 130, the storage device 150, and/or any other component of the imaging system 100. In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

Merely for illustration, only one processor is described in the computing device 200. However, it should be noted that the computing device 200 in the present disclosure may also include multiple processors, thus operations and/or method operations that are performed by one processor as described in the present disclosure may also be jointly or separately performed by the multiple processors. For example, if in the present disclosure the processor of the computing device 200 executes both operation A and operation B, it should be understood that operation A and operation B may also be performed by two or more different processors jointly or separately in the computing device 200 (e.g., a first processor executes operation A and a second processor executes operation B, or the first and second processors jointly execute operations A and B).

The storage device 220 may store data/information obtained from the imaging device 110, the terminal(s) 130, the storage device 150, and/or any other component of the imaging system 100. In some embodiments, the storage device 220 may include a mass storage device, a removable storage device, a volatile read-and-write memory, a read-only memory (ROM), or the like, or any combination thereof. In some embodiments, the storage device 220 may store one or more programs and/or instructions to perform exemplary methods described in the present disclosure.

The I/O 230 may input and/or output signals, data, information, etc. In some embodiments, the I/O 230 may enable a user interaction with the processing device 140. In some embodiments, the I/O 230 may include an input device and an output device. The input device may include alphanumeric and other keys that may be input via a keyboard, a touch screen (for example, with haptics or tactile feedback), a speech input, an eye tracking input, a brain monitoring system, or any other comparable input mechanism. The input information received through the input device may be transmitted to another component (e.g., the processing device 140) via, for example, a bus, for further processing. Other types of the input device may include a cursor control device, such as a mouse, a trackball, or cursor direction keys, etc. The output device may include a display (e.g., a liquid crystal display (LCD), a light-emitting diode (LED)-based display, a flat panel display, a curved screen, a television device, a cathode ray tube (CRT), a touch screen), a speaker, a printer, or the like, or a combination thereof.

The communication port 240 may be connected to a network (e.g., the network 120) to facilitate data communications. The communication port 240 may establish connections between the processing device 140 and the imaging device 110, the terminal(s) 130, and/or the storage device 150. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee™ link, a mobile network link (e.g., 3G, 4G, 5G), or the like, or a combination thereof. In some embodiments, the communication port 240 may be and/or include a standardized communication port, such as RS232, RS485, etc. In some embodiments, the communication port 240 may be a specially designed communication port. For example, the communication port 240 may be designed in accordance with the digital imaging and communications in medicine (DICOM) protocol.

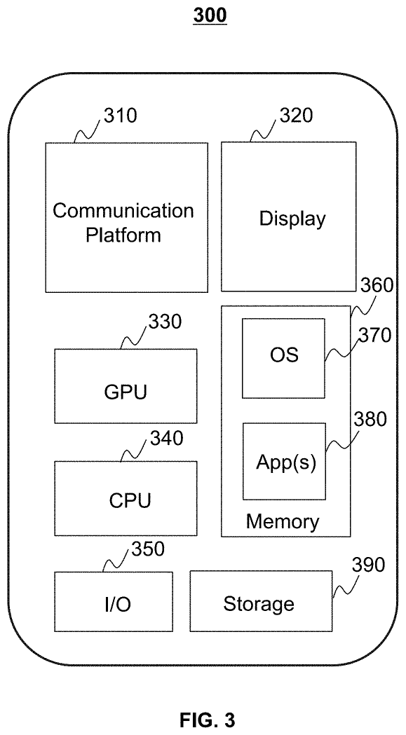

FIG. 3 is a schematic diagram illustrating exemplary hardware and/or software components of a mobile device 300 according to some embodiments of the present disclosure. In some embodiments, one or more components (e.g., a terminal 130 and/or the processing device 140) of the imaging system 100 may be implemented on the mobile device 300.

As illustrated in FIG. 3, the mobile device 300 may include a communication platform 310, a display 320, a graphics processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™) and one or more applications 380 may be loaded into the memory 360 from the storage 390 in order to be executed by the CPU 340. The applications 380 may include a browser or any other suitable mobile apps for receiving and rendering information relating to image processing or other information from the processing device 140. User interactions with the information stream may be achieved via the I/O 350 and provided to the processing device 140 and/or other components of the imaging system 100 via the network 120.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

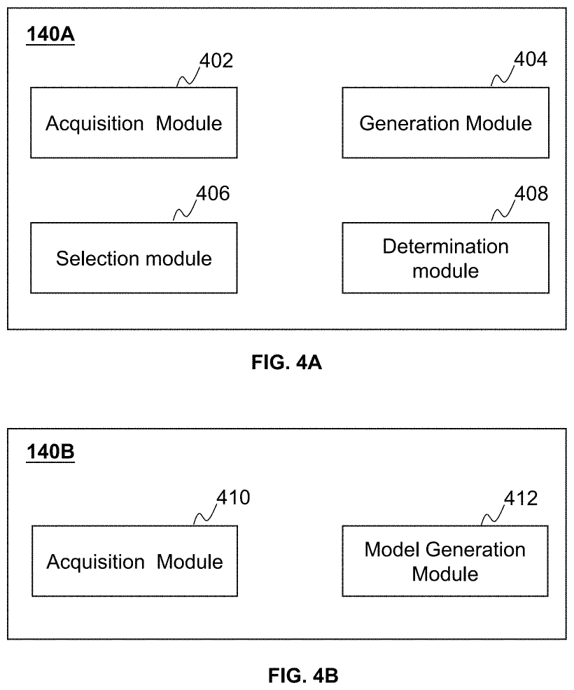

FIGS. 4A and 4B are block diagrams illustrating exemplary processing devices 140A and 140B according to some embodiments of the present disclosure. The processing devices 140A and 140B may be exemplary processing devices 140 as described in connection with FIG. 1. In some embodiments, the processing device 140A may be configured to apply one or more machine learning models in generating a target 2D image of an MPR plane. The processing device 140B may be configured to generate the one or more machine learning models. In some embodiments, the processing devices 140A and 140B may be respectively implemented on a processing unit (e.g., a processor 210 illustrated in FIG. 2 or a CPU 340 as illustrated in FIG. 3). Merely by way of example, the processing devices 140A may be implemented on a CPU 340 of a terminal device, and the processing device 140B may be implemented on a computing device 200. Alternatively, the processing devices 140A and 140B may be implemented on a same computing device 200 or a same CPU 340. For example, the processing devices 140A and 140B may be implemented on a same computing device 200.

As shown in FIG. 4A, the processing device 140A may include an acquisition module 402, a generation module 404, a selection module 406, and a determination module 408.

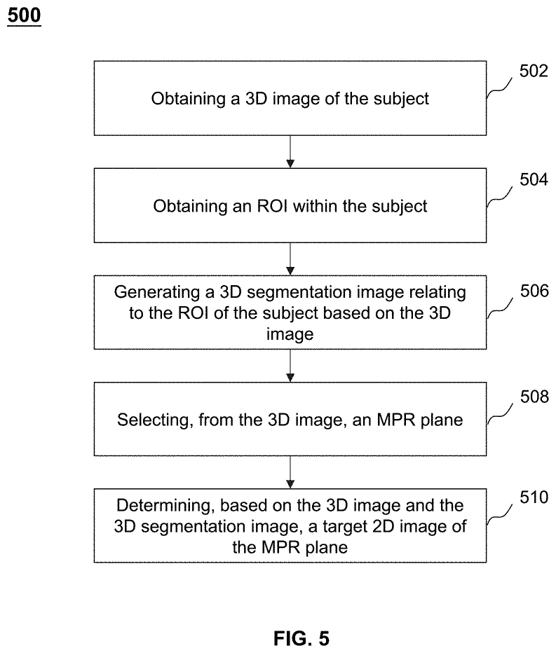

The acquisition module 402 may be configured to obtain information relating to the imaging system 100. For example, the acquisition module 402 may obtain a 3D image of a subject. The 3D image may include a medical image generated by a biomedical imaging technique as described elsewhere in this disclosure. As another example, he acquisition module 402 may obtain an ROI within the subject. An ROI of a subject refers to a physical region of interest of the subject or a portion in an image that corresponds to the physical region of interest. For example, the ROI of the subject may include one or more specific organs and/or one or more specific tissues of, or the whole body of the subject. More descriptions regarding the obtaining of the 3D image and the ROI may be found elsewhere in the present disclosure. See, e.g., operations 502 and 504 in FIG. 5 and relevant descriptions thereof.

The generation module 404 may be configured to generate a 3D segmentation image of an ROI (or referred to as a 3D segmentation image relating to the ROI) of the subject based on the 3D image. The 3D segmentation image of the ROI may be an image that indicates a portion corresponding to the ROI segmented from or identified in the 3D image. In some embodiments, the 3D segmentation image of the ROI may be generated manually. Alternatively, the 3D segmentation image may be generated by the processing device 140A automatically or semi-automatically according to an image analysis algorithm (e.g., an image segmentation algorithm). In some embodiments, the 3D segmentation image may be segmented from the 3D image using an ROI segmentation model. More descriptions regarding the generation of the 3D segmentation image may be found elsewhere in the present disclosure. See, e.g., operation 506 in FIG. 5 and relevant descriptions thereof.

The selection module 406 may be configured to select an MPR plane from the 3D image. As used herein, an MPR plane refers to a physical plane (e.g., a sagittal plane, a coronal plane, an axial plane, or any other oblique plane) of the subject whose target image is to be reconstructed. The “selecting an MPR plane from the 3D image” refers to selecting or locating an image plane that corresponds to the MRI plane of the subject from the 3D image. In some embodiments, the MPR plane may be selected from the 3D image by the processing device 140A automatically. For example, the processing device 140A may determine the MPR plane based on a central point and a normal vector of the MPR plane in the 3D image. As another example, the processing device 140A may determine the MPR plane based on two orthogonal vectors in the 3D image. In some embodiments, the MPR plane may be selected from the 3D image manually by a user (e.g., a doctor, an imaging specialist, a technician). More descriptions regarding the selection of the MPR plane may be found elsewhere in the present disclosure. See, e.g., operation 508 in FIG. 5 and relevant descriptions thereof.

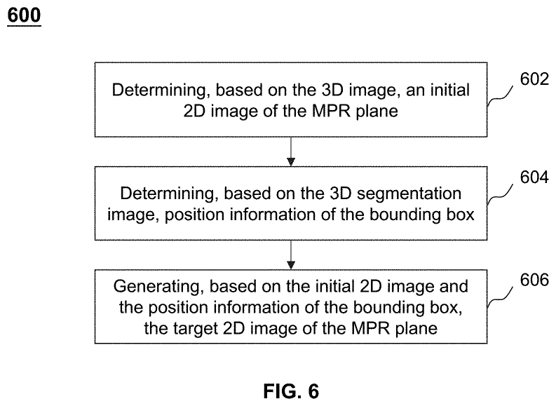

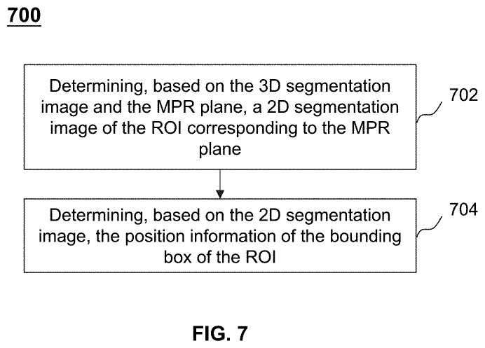

The determination module 408 may be configured to determine a target 2D image of the MPR plane based on the 3D image and the 3D segmentation image. A target 2D image of an MPR plane refers to a 2D image of the MPR plane in which the ROI on the MPR plane is marked or labeled. For example, the target 2D image of the MPR plane may include a bounding box annotating the ROI on the MPR plane. The bounding box may enclose the ROI on the MPR plane. In some embodiments, the processing device 140A may generate an initial 2D image (or referred to as a pixel plane) corresponding to the MPR plane selected. The processing device 140A may determine position information of the bounding box based on the 3D segmentation image. The processing device 140A may further generate the target 2D image based on the position information of the bounding box and the initial 2D image. More descriptions for the generation of the target 2D image of the MPR plane may be found elsewhere in the present disclosure. See, e.g., operation 510 in FIG. 5, FIG. 6, FIG. 7, and relevant descriptions thereof.

As shown in FIG. 4B, the processing device 140B may include an acquisition module 410 and a model generation module 412.

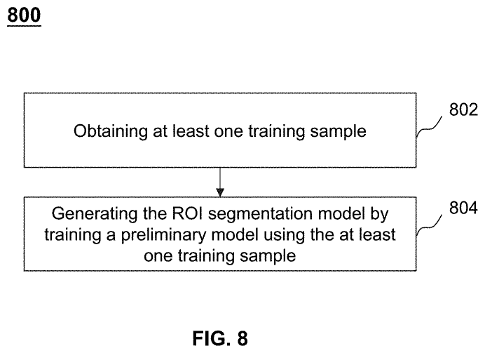

The acquisition module 410 may be configured to obtain at least one training sample. Each of the at least one training sample may include a sample 3D image of a sample subject and a ground truth 3D segmentation image of a sample ROI of the sample subject. More descriptions regarding the acquisition of the at least one training sample may be found elsewhere in the present disclosure. See, e.g., operation 802 in FIG. 8, and relevant descriptions thereof.

The model generation module 412 may be configured to generate the ROI segmentation model by training a preliminary model using the at least one training sample. In some embodiments, the one or more machine learning models may be generated according to a machine learning algorithm. Exemplary machine learning algorithms may include an artificial neural network algorithm, a deep learning algorithm, a decision tree algorithm, an association rule algorithm, an inductive logic programming algorithm, a support vector machine algorithm, a clustering algorithm, a Bayesian network algorithm, a reinforcement learning algorithm, a representation learning algorithm, a similarity and metric learning algorithm, a sparse dictionary learning algorithm, a genetic algorithm, a rule-based machine learning algorithm, or the like, or any combination thereof. The machine learning algorithm used to generate the one or more machine learning models may be a supervised learning algorithm, a semi-supervised learning algorithm, an unsupervised learning algorithm, or the like. More descriptions regarding the generation of the ROI segmentation model may be found elsewhere in the present disclosure. See, e.g., operation 804 in FIG. 8, and relevant descriptions thereof.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the processing device 140A and/or the processing device 140B may share two or more of the modules, and any one of the modules may be divided into two or more units. For instance, the processing devices 140A and 140B may share a same acquisition module; that is, the acquisition module 402 and the acquisition module 410 are a same module. In some embodiments, the processing device 140A and/or the processing device 140B may include one or more additional modules, such as a storage module (not shown) for storing data. In some embodiments, the processing device 140A and the processing device 140B may be integrated into one processing device 140.

FIG. 5 is a flowchart illustrating an exemplary process for generating a target 2D image of an MPR plane of a subject according to some embodiments of the present disclosure. In some embodiments, the process 500 may be implemented in the imaging system 100 illustrated in FIG. 1. For example, the process 500 may be stored in a storage (e.g., the storage device 150, the storage device 220, the storage 390) as a form of instructions, and invoked and/or executed by the processing device 140A (e.g., the processor 210 of the computing device 200 as illustrated in FIG. 2, the CPU 340 of the mobile device 300 as illustrated in FIG. 3, and/or one or more modules as illustrated in FIG. 4A). The operations of the illustrated process presented below are intended to be illustrative. In some embodiments, the process 500 may be accomplished with one or more additional operations not described, and/or without one or more of the operations discussed. Additionally, the order in which the operations of the process 500 as illustrated in FIG. 5 and described below is not intended to be limiting.

In 502, the processing device 140A (e.g., the acquisition module 402) may obtain a 3D image of the subject.

As used herein, the subject may include a biological subject and/or a non-biological subject. For example, the subject may be a human being, an animal, or a portion thereof. As another example, the subject may be a phantom. In some embodiments, the subject may be a patient, or a portion of the patient (e.g., the chest, the breast, and/or the abdomen of the patient).

In some embodiments, the 3D image may include a medical image generated by a biomedical imaging technique as described elsewhere in this disclosure. For example, the 3D image may include an MR image, a PET image, a CT image, a PET-CT image, a PET-MR image, an ultrasound image, etc. In some embodiments, the 3D image may include a single 3D image or a set of 3D images of the subject. For example, the 3D image may include multiple 3D medical images of the subject obtained with different imaging parameters (different scan sequences, different imaging modalities, different postures of the subject, etc.). In some embodiments, the 3D image may be in a Digital Imaging Communication in Medicine (DICOM) format.

In some embodiments, the 3D image may be generated based on image data acquired using the imaging device 110 of the imaging system 100 or an external imaging device. For example, the imaging device 110, such as a CT device, an MRI device, an X-ray device, a PET device, or the like, may be directed to scan the subject or a portion of the subject (e.g., the chest of the subject). The processing device 140A may generate the 3D image based on image data acquired by the imaging device 110. In some embodiments, the 3D image may be previously generated and stored in a storage device (e.g., the storage device 150, the storage device 220, the storage 390, or an external source). The processing device 140A may retrieve the 3D image from the storage device.

In 504, the processing device 140A (e.g., the acquisition module 402) may obtain an ROI within the subject.

An ROI of a subject refers to a physical region of interest of the subject or a portion in an image that corresponds to the physical region of interest. For example, the ROI of the subject may include one or more specific organs and/or one or more specific tissues of, or the whole body of the subject. Merely by way of example, the ROI may include the head, the chest, a lung, the heart, the liver, the spleen, the pleura, the mediastinum, the abdomen, the large intestine, the small intestine, the bladder, the gallbladder, the pelvis, the spine, the skeleton, blood vessels, the duodenum, or the like, or any combination thereof, of a patient. In some embodiments, the ROI may include a lesion of the subject. A lesion refers to damage (or potential damage) and/or an abnormal change (or potential change) in the tissue of the subject, usually caused by disease or trauma. For example, the ROI may include a polycystic kidney of a patient caused by autosomal dominant polycystic kidney disease (ADPKD).

In some embodiments, the processing device 140A may obtain or determine the ROI within the subject. For example, the processing device 140A may transmit the 3D image of the subject to a user terminal for display, and the ROI may be selected by a user (e.g., a doctor) based on the 3D image displayed on the user terminal. As another example, the ROI may be determined by the processing device 140A based on the 3D image (for example, by identifying a lesion region from the 3D image as the ROI). As yet another example, the ROI to be analyzed may be determined by the processing device 140A based on a default setting of the imaging system 100 and/or a scanning or treatment protocol of the subject.

In 506, the processing device 140A (e.g., the generation module 404) may generate a 3D segmentation image of an ROI (or referred to as a 3D segmentation image relating to the ROI) of the subject based on the 3D image.

The 3D segmentation image of the ROI may be an image that indicates a portion corresponding to the ROI segmented from or identified in the 3D image. In some embodiments, the 3D segmentation image of the ROI may be represented in various forms. For example, the 3D segmentation image of the ROI may be represented as a binary segmentation mask of the ROI. In the binary segmentation mask, a voxel corresponding to the ROI may be displayed in black, and a voxel corresponding to the remaining region may be displayed in white. As another example, the binary segmentation mask may be represented as a matrix in which elements representing physical points of the ROI have a label of “1” and elements representing physical points out of the ROI have a label of “0”.

In some embodiments, the ROI may include a plurality of organs or tissues. In the 3D segmentation image, elements (e.g., voxels) corresponding to different organs or tissues may be displayed in different colors or annotated with different labels (e.g., “1,” “2,” and “3”). For example, an ROI relating to the heart of a subject may include a left ventricle, a left atrium, a right ventricle, a right atrium, a vena cava, a pulmonary artery, an aorta, etc. In a 3D segmentation image relating to the heart of the subject, elements corresponding to the left ventricle, elements corresponding to the left atrium, elements corresponding to the right ventricle, elements corresponding to the right atrium, elements corresponding to the vena cava, elements corresponding to the pulmonary artery, and elements corresponding to the aorta may be annotated with label “1,” “2,” “3,” “4,” “5,” “6,” and “7,” respectively.

In some embodiments, the 3D segmentation image of the ROI may be generated manually. Merely by way of example, the portion corresponding to the ROI may be segmented from the 3D image manually by a user (e.g., a doctor, an imaging specialist, a technician) by, for example, drawing a bounding box on the 3D image displayed on a user interface. Alternatively, the 3D segmentation image may be generated by the processing device 140A automatically according to an image analysis algorithm (e.g., an image segmentation algorithm). For example, the processing device 140A may perform image segmentation on the 3D image using an image segmentation algorithm. Exemplary image segmentation algorithm may include a thresholding segmentation algorithm, a compression-based algorithm, an edge detection algorithm, a machine learning-based segmentation algorithm, or the like, or any combination thereof. Alternatively, the 3D segmentation image may be segmented by the processing device 140A semi-automatically based on an image analysis algorithm in combination with information provided by a user. Exemplary information provided by the user may include a parameter relating to the image analysis algorithm, a position parameter relating to a region to be segmented, an adjustment to, or rejection or confirmation of a preliminary segmentation result generated by the processing device 140A, etc.

In some embodiments, the 3D segmentation image may be segmented from the 3D image using an ROI segmentation model. The ROI segmentation model may be a trained model (e.g., a machine learning model) used for ROI segmentation (or detection). Merely by way of example, the 3D image may be inputted into the ROI segmentation model, and the ROI segmentation model may directly output the 3D segmentation image. Alternatively, the ROI segmentation model may output information (e.g., boundary information) relating to the ROI, and the processing device 140A may generate the 3D segmentation image based on the information relating to the ROI. For example, the ROI segmentation model may output a probability map including a probability value that each voxel of the subject belongs to the ROI. The processing device 140A may determine the 3D segmentation image by selecting voxels whose probability values exceed a threshold value. In some embodiments, the ROI segmentation model may include a deep learning model, such as a Deep Neural Network (DNN) model, a Convolutional Neural Network (CNN) model, a Recurrent Neural Network (RNN) model, a Feature Pyramid Network (FPN) model, etc. Exemplary CNN models may include a V-Net model, a U-Net model, a Link-Net model, or the like, or any combination thereof.

In some embodiments, the processing device 140A may obtain the ROI segmentation model from one or more components of the imaging system 100 (e.g., the storage device 150, the terminals(s) 130) or an external source via a network (e.g., the network 120). For example, the ROI segmentation model may be previously trained by a computing device (e.g., the processing device 140B), and stored in a storage device (e.g., the storage device 150, the storage device 220, and/or the storage 390) of the imaging system 100. The processing device 140A may access the storage device and retrieve the ROI segmentation model. In some embodiments, the ROI segmentation model may be generated according to a machine learning algorithm as described elsewhere in this disclosure (e.g., FIG. 4B and the relevant descriptions). More descriptions for the generation of the ROI segmentation model may be found elsewhere in the present disclosure (e.g., FIG. 8 and the descriptions thereof).

In some embodiments, the processing device 140A may transmit the 3D image of the subject to another computing device (e.g., a computing device of a vendor of the ROI segmentation model). The computing device may generate the 3D segmentation image of the ROI based on the 3D image, and transmit the segmentation result back to the processing device 140A. In some embodiments, operation 506 may be omitted. The 3D segmentation image may be previously segmented from the 3D image and stored in a storage device (e.g., the storage device 150, the storage device 220, the storage 390, or an external source). The processing device 140A may retrieve the 3D segmentation image from the storage device.

In some embodiments, the ROI may include multiple sub-ROIs. For each of the sub-ROIs (or a portion of the sub-ROIs), the processing device 140A may generate a 3D segmentation image of the sub-ROI by processing the 3D image using a specific ROI segmentation model corresponding to the sub-ROI. For example, the ROI of the subject may include multiple sub-ROIs, such as the stomach, the spleen, the liver, the duodenum, etc. The processing device 140A may generate a first 3D segmentation image of the stomach by processing the 3D image using an ROI segmentation model corresponding to the stomach, and a second 3D segmentation image of the spleen by processing the 3D image using an ROI segmentation model corresponding to the spleen. Alternatively, the processing device 140A may generate a single 3D segmentation image of the sub-ROIs (or a portion thereof) by processing the 3D image using an ROI segmentation model that can segment the sub-ROIs (or a portion thereof) jointly. In some embodiments, the processing device 140A may select one or more sub-ROIs from the multiple sub-ROIs, and obtain or generate one or more specific ROI segmentation models corresponding to the one or more sub-ROIs. For each of the selected sub-ROI(s), the processing device 140A may select an ROI segmentation model corresponding to the sub-ROI from the one or more ROI segmentation models, and utilize the selected ROI segmentation model for generating the 3D segmentation image of the sub-ROI.

In 508, the processing device 140A (e.g., the selection module 406) may select, from the 3D image, an MPR plane.

As used herein, an MPR plane refers to a physical plane (e.g., a sagittal plane, a coronal plane, an axial plane, or any other oblique plane) of the subject whose target image is to be reconstructed. The “selecting an MPR plane from the 3D image” refers to selecting or locating an image plane that corresponds to the MRI plane of the subject from the 3D image. For the convenience of descriptions, the term “MPR plane” is used herein to collectively refers to a plane existing in the subject's body and its corresponding image plane shown in the 3D image.

In some embodiments, the MPR plane may be selected from the 3D image by the processing device 140A automatically. For example, the processing device 140A may determine an image plane from the 3D image that passes through the ROI and is suitable for a user (e.g., a doctor) to inspect the ROI, and designate the image plane as the MPR plane. In some embodiments, the processing device 140A may determine a central point and a normal vector of the MPR plane in the 3D image. For example, the central point of the MPR plane may be any point (e.g., a central point, a gravity point) of the ROI. The normal vector refers to a vector that is perpendicular to the MPR plane at a specific point (e.g., the central point). Alternatively, the central point and the normal vector of the MPR plane may be determined from the 3D image manually by a user on the 3D image displayed on a user interface. The processing device 140A may further determine the MPR plane based on the central point and the normal vector of the MPR plane.

As another example, the processing device 140A may determine two orthogonal vectors in the 3D image. The two orthogonal vectors may be any two vectors perpendicular to each other, such as two of a vector perpendicular to an axial plane of the subject, a vector perpendicular to a coronal plane of the subject, and a vector perpendicular to a sagittal plane of the subject. Alternatively, the two orthogonal vectors may be determined from the 3D image manually by a user on the 3D image displayed on a user interface. The processing device 140A may further determine an image plane that passes through both the two orthogonal vectors as the MPR plane.

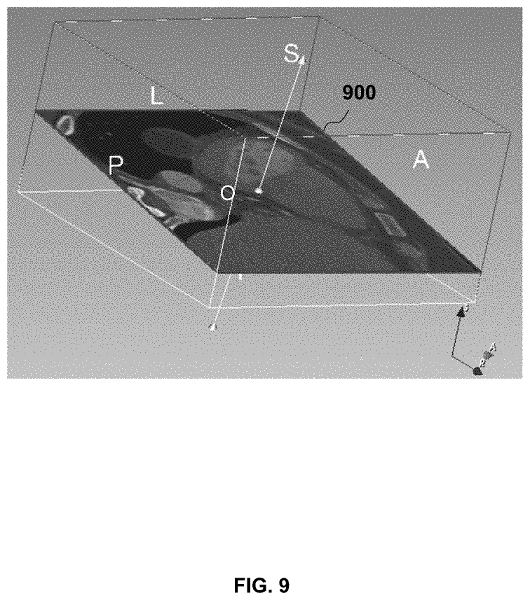

Merely by way of example, FIG. 9 is a schematic diagram illustrating an exemplary MPR plane 900 according to some embodiments of the present disclosure. As shown in FIG. 9, a central point of the MPR plane 900 is located at a point O and a normal vector of the MPR plane is represented as a white arrow. The normal vector passes through the central point O and is perpendicular to the MPR plane 900. The labels “L,” “P,” “S,” and “A” in FIG. 9 may represent the left direction, the posterior direction, the superior direction, and the anterior direction, respectively.

In some embodiments, the MPR plane may be selected from the 3D image manually by a user (e.g., a doctor, an imaging specialist, a technician). For example, a user may select an image plane from the 3D image as the MPR plane via an image processing application or software (e.g., an interactive software) installed in a user terminal. Merely by way of example, the image processing application may display the 3D image and a preliminary MPR plane with a normal vector and a central point of a preliminary MPR plane. The user may drag the central point and/or rotate the normal vector to adjust the preliminary MPR plane. The adjusted MPR plane may be used as the MPR plane.

In 510, the processing device 140A (e.g., the determination module 408) may determine, based on the 3D image and the 3D segmentation image, a target 2D image of the MPR plane.

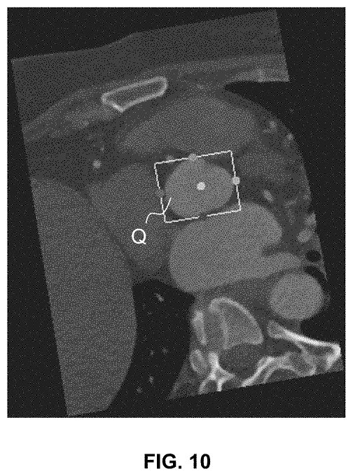

A target 2D image of an MPR plane refers to a 2D image of the MPR plane in which the ROI on the MPR plane is marked or labeled. For example, the target 2D image of the MPR plane may include a bounding box annotating the ROI on the MPR plane. The bounding box may enclose the ROI on the MPR plane. The bounding box may have the shape of a square, a rectangle, a triangle, a polygon, a circle, an ellipse, an irregular shape, or the like. Merely by way of example, FIG. 10 is a schematic diagram illustrating an exemplary target 2D image of an MPR plane according to some embodiments of the present disclosure. As shown in FIG. 10, the target 2D image includes an ROI Q, and a white rectangular bounding box enclosing the ROI Q.

In some embodiments, the processing device 140A may generate an initial 2D image (or referred to as a pixel plane) corresponding to the MPR plane selected in operation 508. The processing device 140A may determine position information of the bounding box based on the 3D segmentation image. The processing device 140A may further generate the target 2D image based on the position information of the bounding box and the initial 2D image. More descriptions for the generation of the target 2D image of the MPR plane may be found elsewhere in the present disclosure (e.g., FIG. 6 and the descriptions thereof).

In some embodiments, the ROI may include multiple sub-ROIs. The processing device 140A may select one or more target sub-ROIs from the multiple sub-ROIs. The bounding box of the target 2D image may annotate the one or more target sub-ROIs on the MPR plane. For example, the bounding box may include one or more sub-bounding boxes, each of which annotates one of the target sub-ROI(s).

It should be noted that the above description regarding the process 500 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the process 500 may be accomplished with one or more additional operations not described and/or without one or more of the operations discussed above. For example, the process 500 may include an additional operation to transmit the determined target 2D image to a terminal device (e.g., a terminal device 130 of a doctor) for display. As another example, the process 500 may include an additional storing operation to store information and/or data (e.g., the 3D image, the target 2D image, etc.) in a storage device (e.g., the storage device 150) disclosed elsewhere in the present disclosure.

FIG. 6 is a flowchart illustrating an exemplary process for generating a target 2D image of an MPR plane according to some embodiments of the present disclosure. In some embodiments, one or more operations of the process 600 may be performed to achieve at least part of operation 510 as described in connection with FIG. 5.

In 602, the processing device 140A (e.g., the determination module 408) may determine, based on the 3D image, an initial 2D image of the MPR plane.

The initial 2D image may be a pixel plane in the 3D image corresponding to the MPR plane of the subject. The initial 2D image may include a plurality of first pixels corresponding to a plurality of physical points on the MPR plane, and each first pixel may have a first pixel value of a corresponding physical point on the MPR plane. A physical point on the MPR plane refers to a portion of the subject that corresponds to a voxel on the MPR plane in the 3D image.

In some embodiments, the processing device 140A may identify a first voxel corresponding to each physical point on the MPR plane from the 3D image. Merely by way of example, for a physical point, the processing device 140A may determine a coordinate of a corresponding first voxel in the 3D image by performing a coordinate transformation according to a transformation relationship. The transformation relationship refers to a relationship between a coordinate of a physical point on the MPR plane and a coordinate of a first voxel corresponding to the physical point in the 3D image. For example, the 3D image may correspond to a 3D coordinate system including an X′-axis, a Y′-axis, and a Z′-axis based on the 3D image, and the MPR plane may correspond to a 2D coordinate system including a first coordinate axis (e.g., an X-axis) and a second coordinate axis (e.g., a Y-axis). The processing device 140A may determine a coordinate of a first voxel corresponding to a physical point on the MPR plane according to Equations (1)-(3) as below:

x̅=x₀+xx₁\sqrt{x₁²+y₁²+z₁²}+yx₂\sqrt{x₂²+y₂²+z₂²}, (1)

y̅=y₀+xy₁\sqrt{x₁²+y₁²+z₁²}+yy₂\sqrt{x₂²+y₂²+z₂²}, (2)

z̅=z₀+xz₁\sqrt{x₁²+y₁²+z₁²}+yz₂\sqrt{x₂²+y₂²+z₂²}, (3)

where (x̅, y̅, z̅) denotes the coordinate of the first voxel in the 3D coordinate system, (x₀, y₀, z₀) denotes a coordinate of a central point of the MPR plane in the 3D coordinate system, (x, y) denotes the coordinate of the physical point in the 2D coordinate system, (x₁, yₗ, z₁) denotes a first vector representing the first coordinate axis of the 2D coordinate system in the 3D coordinate system, and (x₂, y₂, z₂) denotes a second vector representing the second coordinate axis of the 2D coordinate system in the 3D coordinate system.

The processing device 140A may then determine a first pixel value of each physical point based on the 3D image and the first voxel. For example, for a physical point, the processing device 140A may determine a voxel value of the corresponding first voxel in the 3D image, and designate the voxel value as the first pixel value of the physical point. The processing device 140A may further generate the initial 2D image based on the first pixel value of each physical point on the MPR plane. For example, for each physical point on the MPR plane, the processing device 140A may designate the first pixel value of the physical point as a pixel value of a first pixel corresponding to the physical point. The first pixels corresponding to the physical points of the MPR plane may form the initial 2D image.

In 604, the processing device 140A (e.g., the determination module 408) may determine, based on the 3D segmentation image, position information of the bounding box.

The position information of the bounding box may include, for example, a coordinate of each point at the bounding box (e.g., a coordinate of each point at the bounding box in the 2D coordinate system corresponding to the MPR plane), position information of one or more vertices of the bounding box, position information of one or more edges of the bounding box, etc. In some embodiments, the processing device 140A may determine a 2D segmentation image of the ROI corresponding to the MPR plane based on the 3D segmentation image and the MPR plane. The processing device 140A may further determine the position information of the bounding box of the ROI based on the 2D segmentation image. More descriptions for the determination of the position information of the bounding box may be found elsewhere in the present disclosure (e.g., FIG. 7 and the descriptions thereof). In some embodiments, operation 604 may be performed before or at the same time as operation 602.

In 606, the processing device 140A (e.g., the determination module 408) may generate, based on the initial 2D image and the position information of the bounding box, the target 2D image of the MPR plane.

In some embodiments, the processing device 140A may generate the target 2D image by annotating the bounding box on the initial 2D image based on the position information of the bounding box. For example, the processing device 140A may determine points corresponding to the bounding box in the initial 2D image based on the position information of the bounding box, and draw the bounding box on the initial 2D image to generate the target 2D image.

According to some embodiments of the present disclosure, for each physical point on the MPR plane, the processing device 140A may determine a coordinate of a corresponding first voxel in the 3D image by performing a coordinate transformation according to a transformation relationship, and determine a first pixel value of the physical point based on the 3D image and the coordinate of the corresponding first voxel. The processing device 140A may further generate the initial 2D image based on the first pixel value of each physical point. In this way, the initial 2D image of the MPR plane may be generated in an efficient and simple manner, which may further improve the generation efficiency of the target 2D image and achieve an instant display of the target 2D image. As used herein, an instant display of the target 2D image may be achieved if the time difference between the display of the target 2D image and a reference time point (e.g., when a request for displaying the target 2D image is received, when the 3D image of the subject is obtained, when a user selects the MPR plane) is shorter than a threshold.

FIG. 7 is a flowchart illustrating an exemplary process for determining position information of a bounding box of an ROI according to some embodiments of the present disclosure. In some embodiments, one or more operations of the process 700 may be performed to achieve at least part of operation 604 as described in connection with FIG. 6.

In 702, the processing device 140A (e.g., the determination module 408) may determine, based on the 3D segmentation image and the MPR plane, a 2D segmentation image of the ROI corresponding to the MPR plane.

For example, the 2D segmentation image of the ROI corresponding to the MPR plane may be a pixel plane of the ROI corresponding to the MPR plane in the 3D segmentation image. In some embodiments, the 2D segmentation image may include a plurality of second pixels corresponding to the physical points on the MPR plane, and each second pixel may have a second pixel value of a corresponding physical point on the MPR plane. A second pixel value of each physical point on the MPR plane may indicate whether the physical point belongs to the ROI on the MPR plane. In some embodiments, in the 2D segmentation image, the second pixel value of each physical point of each physical point on the MPR plane may be a label value indicating whether the physical point belongs to the ROI on the MPR plane.

In some embodiments, for each physical point on the MPR plane, the processing device 140A may identify a second voxel corresponding to the physical point from the 3D segmentation image. Merely by way of example, for a physical point, the processing device 140A may determine a coordinate of its corresponding second voxel in the 3D segmentation image by performing a coordinate transformation. For example, the determination of the coordinate of a second voxel may be performed in a similar manner as the determination of the coordinate of a first voxel as described in connection with operation 602, and the descriptions thereof are not repeated here.

For each physical point, the processing device 140A may then determine a second pixel value of the physical point based on the 3D segmentation image and its corresponding second voxel. For example, for a physical point, the processing device 140A may determine a voxel value or a label value of its corresponding second voxel in the 3D segmentation image, and designate the voxel value or the label value as the second pixel value of the physical point. The processing device 140A may further generate the 2D segmentation image based on the second pixel value of each physical point on the MPR plane. For example, for each physical point on the MPR plane, the processing device 140A may designate the second pixel value of the physical point as a pixel value of a second pixel corresponding to the physical point. The second pixels corresponding to the physical points of the MPR plane may form the 2D segmentation image.

As described in connection with operation 602, an initial 2D image that includes a plurality of first pixels corresponding to the physical points on the MPR plane may be generated. It should be noted that each second pixel in the 2D segmentation image may have a corresponding a first pixel in the initial 2D image, and the second pixel and its corresponding first pixel may correspond to a same physical point on the MPR plane. In other words, the initial 2D image and the 2D segmentation image may correspond to a same plane in physical space (i.e., the MPR plane).

In 704, the processing device 140A (e.g., the determination module 408) may determine, based on the 2D segmentation image, the position information of the bounding box of the ROI.

In some embodiments, as described in connection with FIG. 6, the MPR plane may correspond to a 2D coordinate system including a first coordinate axis and a second coordinate axis. The processing device 140A may determine a 2D coordinate of each second pixel of the 2D segmentation image in the 2D coordinate system. The processing device 140A may further determine the position information of the bounding box of the ROI based on the 2D coordinate of each second pixel of the 2D segmentation image.

Merely by way of example, the processing device 140A may determine at least one first value of the ROI on the first coordinate axis and at least one second value of the ROI on the second coordinate axis based on the 2D coordinate of each pixel of the 2D segmentation image of the ROI. A first value of the ROI refers to a coordinate value on the first coordinate axis of a second pixel in the 2D segmentation image that belongs to the ROI. A second value of the ROI refers to a coordinate value on the second coordinate axis of a second pixel in the 2D segmentation image that belongs to the ROI. The processing device 140A may further determine a first maximum value and a first minimum value of the ROI based on the at least one first value of the ROI on the first coordinate axis. The first maximum value and the first minimum value may be the maximum value and the minimum value among the at least one first value, respectively. The processing device 140A may also determine a second maximum value and a second minimum value of the ROI based on the at least one second value of the ROI on the second coordinate axis. The second maximum value and the second minimum value may be the maximum value and the minimum value among the at least one second value, respectively. For example, the at least one first value and the at least one second value may be ranked in ascending order or descending order, respectively. The processing device 140A may determine the first maximum value, the first minimum value, the second maximum value, and the second minimum value based on the ranking results. The processing device 140A may further determine the position information of the bounding box based on the first maximum value, the first minimum value, the second maximum value, and the second minimum value.

In some embodiments, the processing device 140A may determine position information of one or more vertices and/or one or more edges of the bounding box in the 2D coordinate system. For example, the bounding box may have the shape of a rectangle. The coordinates of four vertices of the bounding box in the 2D coordinate system may be determined. The coordinates of the four vertices may be (the first minimum value, the second maximum value), (the first maximum value, the second minimum value), (the first minimum value, the second minimum value), and (the first maximum value, the second maximum value). Additionally or alternatively, four edges of the rectangle bounding box may be determined. A first edge may pass through the point (the first maximum value, the second maximum value) and the point (the first maximum value, the second minimum value). A second edge may pass through the point (the first maximum value, the second maximum value) and the point (the first minimum value, the second maximum value). A third edge may pass through the point (the first minimum value, the second minimum value) and the point (the first maximum value, the second minimum value). A fourth edge may pass through the point (the first minimum value, the second minimum value) and the point (the first minimum value, the second maximum value).

Merely by way of example, it is assumed that the first maximum value is equal to 9, the first minimum value is equal to 3, the second maximum value is equal to 10, and the second minimum value is equal to 2. The processing device 140A may determine that the coordinates of the four vertices of the bounding box may be (3, 2), (3, 10), (9, 2), and (9, 10). As another example, the processing device 140A may determine that the first edge passes through (9, 10) and (9, 2), the second edge passes through (9, 10) and (3, 10), the third edge passes through (3, 2) and (9, 2), the fourth edge passes through (3, 2) and (3, 10). In this way, the determined bounding box may have a regular shape and can enclose the entire ROI on the MPR plane, which may facilitate subsequent observation of the ROI.

In some embodiments, the ROI may include multiple sub-ROIs. The processing device 140A or a user may select one or more target sub-ROIs from the multiple sub-ROIs. For example, the multiple sub-ROIs may be annotated with different labels in the 2D segmentation image. The processing device 140A may display the 2D segmentation image with the labels of the multiple sub-ROIs via a user terminal (e.g., the user terminal 140) for a user to select the one or more target sub-ROIs. The bounding box may include one or more bounding boxes of the one or more target sub-ROIs. The determination of the position information of a bounding box of a target sub-ROI may be performed in a similar manner as the determination of the position information of the bounding box of the ROI, and the descriptions thereof are not repeated here.

In some embodiments, for each physical point on the MPR plane, the processing device 140A may determine a coordinate of a corresponding second voxel in the 3D segmentation image by performing a coordinate transformation, and determine a second pixel value of the physical point based on the 3D segmentation image and the coordinate of the corresponding second voxel. The processing device 140A may further generate the 2D segmentation image based on the second pixel value of each physical point and determine the position information of the bounding box of the ROI based on the 2D segmentation image. In this way, the position information of the bounding box of the ROI may be determined in an efficient and simple manner, thereby improving the efficiency of the generation of the target 2D image and achieve an instant display of the target 2D image.

According to some embodiments of the present disclosure, an initial 2D image that includes image data (e.g., pixel values) of the MPR plane may be determined based on the original 3D image, and a 2D segmentation image that includes segmentation information of the ROI on the MPR plane may be determined based on the 3D segmentation image of the ROI. The processing device 140A may further determine the position information of the bounding box of the ROI based on the 2D segmentation image and generate the target 2D image of the MPR plane based on the initial 2D image and the position information of the bounding box. For example, the target 2D image of the MPR plane may be generated by adding the bounding box on the initial 2D image based on the position information of the bounding box. Since the 2D segmentation image and the initial 2D image both correspond to the MPR plane in physical space, the position information of the bounding box may be determined based on the 2D segmentation image, and the bounding box may be added accurately to the initial 2D image based on the position information.

Conventionally, an ROI determination approach is usually inaccurate for some reasons. For example, an ROI on an MPR plane of a subject may be determined from image data of the subject manually by a user (e.g., a doctor) according to experience. Some conventional approaches may have a limited accuracy, for example, generate a bounding box having a larger size than an actual size of the ROI, generate an irregular bounding box, etc. Compared with the conventional approaches, the systems and methods disclosed herein may be fully or partially automated. In addition, the 3D segmentation image may only need to be generated once even if a plurality of target images of different MPR planes need to be generated, which may improve the efficiency of the generation of the target images (e.g., by reducing the processing time, the computational complexity and/or cost) and/or realize a real-time (or substantially real-time) switching display of the target images. For example, if a user selects a specific MPR plane via a user terminal, the systems and methods may be used to generate a target 2D image of the specific MPR plane in a short period (e.g., shorter than a threshold), and the user terminal may be switched to display the target 2D image almost in real-time.

FIG. 8 is a flowchart illustrating an exemplary process for generating an ROI segmentation model according to some embodiments of the present disclosure. In some embodiments, process 800 may be executed by the imaging system 100. For example, the process 800 may be implemented as a set of instructions (e.g., an application) stored in a storage device (e.g., the storage device 150, the storage device 220, and/or the storage 390). In some embodiments, the processing device 140B (e.g., the processor 210 of the computing device 200, the CPU 340 of the mobile device 300, and/or one or more modules illustrated in FIG. 4B) may execute the set of instructions and may accordingly be directed to perform the process 800.

In some embodiments, the ROI segmentation model described in connection with operation 506 in FIG. 5 may be obtained according to the process 800. In some embodiments, the process 800 may be performed by another device or system other than the imaging system 100, e.g., a device or system of a vendor or a manufacturer of the ROI segmentation model. For illustration purposes, the implementation of the process 800 by the processing device 140B is described as an example.

In 802, the processing device 140B (e.g., the acquisition module 410) may obtain at least one training sample.

Each of the at least one training sample may include a sample 3D image of a sample subject and a ground truth 3D segmentation image of a sample ROI of the sample subject. In some embodiments, the sample subject may be of a same type as the subject as described in connection with operation 502. Two subjects may be deemed as being of a same type if they correspond to a same organ or tissue. The sample 3D image of a sample subject may include, for example, an MR image, a PET image, a CT image, a PET-CT image, a PET-MR image, an ultrasound image, or the like, or any combination thereof, of the sample subject. The sample 3D image of the sample subject may be of a same type as or a different type from the 3D image of the subject as described in connection with operation 502. Two images may be deemed as being of a same type if they are acquired using a same imaging modality.

A sample ROI of a sample subject refers to an ROI of the sample subject. A ground truth 3D segmentation image of a sample ROI of a sample subject refers to a 3D segmentation image of the sample ROI of the subject that is determined or confirmed by a user. For example, a sample 3D image of a sample patient may be displayed on a user terminal, and a doctor may draw a contour of a sample ROI of the sample patient on the sample 3D image. A ground truth 3D segmentation image of the sample ROI of the sample patient may be generated based on the contour drew by the doctor. As another example, a preliminary 3D segmentation image of the sample ROI of the sample patient may be generated by a computing device, and the doctor may adjust the preliminary 3D segmentation image to generate the ground truth 3D segmentation image.

In some embodiments, the processing device 140B may obtain a training sample (or a portion thereof) from one or more components of the imaging system 100 (e.g., the storage device 150, the s(s) 130) or an external source (e.g., a database of a third-party) via a network (e.g., terminal the network 120). Alternatively, the training sample (or a portion thereof) may be generated by the processing device 140B. For example, the processing device 140B may obtain an initial training sample, and generate the training sample by preprocessing the initial training sample.

Merely by way of example, the initial training sample may include an initial sample 3D image of a sample subject and/or an initial ground truth 3D segmentation image. The processing device 140B may resample each image of the initial training sample according to a preset resolution (e.g., 3 mm*3 mm*3 mm). For example, the processing device 140B may adjust the voxel spacing of each image of the initial training sample to a same value (e.g., 3 mm). Additionally or alternatively, the processing device 140B may remove background pixels with a pixel value of 0 at the edge in each image of the initial training sample. Additionally or alternatively, the processing device 140B may perform a normalization operation on each image in the initial training sample according to Equation (4) as below:

$${I}^{′} = \frac{I - μ}{σ} , \qquad ( 4 )$$

where I denotes an image to be normalized, I′ denotes a normalized image, μ denotes a mean value of voxel values of the image, and σ denotes a standard deviation of the voxel values of the image.

In 804, the processing device 140B (e.g., the model generation module 412) may generate the ROI segmentation model by training a preliminary model using the at least one training sample.

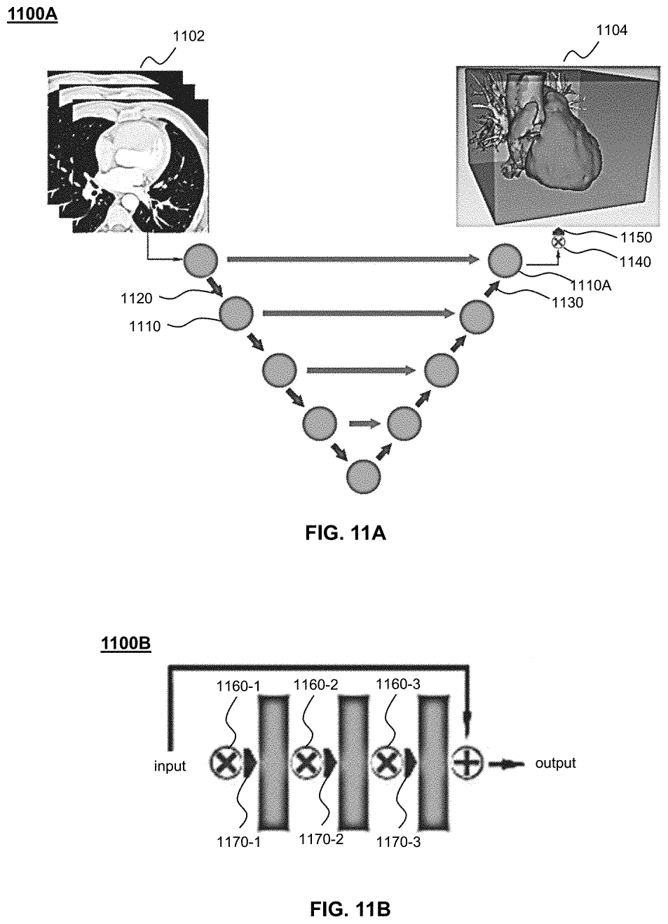

The preliminary model refers to a model to be trained. The preliminary model may be of any type of model (e.g., a machine learning model) as described elsewhere in this disclosure (e.g., FIG. 5 and the relevant descriptions). For example, the preliminary model may be a V-net model as described in connection with FIG. 11A. In some embodiments, the processing device 140B may obtain the preliminary model from one or more components of the imaging system 100 (e.g., the storage device 150, the terminals(s) 130) or an external source (e.g., a database of a third-party) via a network (e.g., the network 120).

The preliminary model may include a plurality of model parameters. For example, the preliminary model may be a CNN model and exemplary model parameters of the preliminary model may include the number (or count) of layers, the number (or count) of kernels, a kernel size, a stride, a padding of each convolutional layer, or the like, or any combination thereof. Before training, the model parameters of the preliminary model may have their respective initial values. For example, the processing device 140B may initialize the parameter values of the model parameters of the preliminary model. Merely for illustration, the processing device 140B may randomly initialize a plurality of weight parameters of the preliminary model by setting the mean value of the weight parameters to 1 and the variance of the weight parameters to 0.

In some embodiments, the training of the preliminary model may include one or more iterations to iteratively update the model parameters of the preliminary model based on the at least one training sample until a termination condition is satisfied in a certain iteration. Exemplary termination conditions may be that the value of a loss function obtained in the certain iteration is less than a threshold value, that a certain count of iterations has been performed, that the loss function converges such that the difference of the values of the loss function obtained in a previous iteration and the current iteration is within a threshold value, etc.

Merely by way of example, an updated preliminary model generated in a previous iteration may be evaluated in the current iteration. The loss function may be used to measure a discrepancy between a segmentation result predicted by the updated preliminary model in the current iteration and the ground truth segmentation result. For example, the sample 3D image of each training sample may be inputted into the updated preliminary model, and the updated preliminary model may output a predicted 3D segmentation image of the sample ROI of the training sample. The loss function may be used to measure a difference between the predicted 3D segmentation image and the ground truth 3D segmentation image of each training sample. Exemplary loss functions may include a focal loss function, a log loss function, a cross-entropy loss, a Dice loss, or the like. For example, the Dice loss may be determined according to Equation (5) as below:

$$d\_loss = \frac{2 {\sum }_{i}^{N} {p}_{i} {g}_{i}}{{\sum }_{i}^{N} {p}_{i}^{2} + {\sum }_{i}^{N} {g}_{i}^{2}} , \qquad ( 5 )$$

where d_loss denotes the value of the Dice loss, i denotes a voxel of the predicted 3D segmentation image outputted by the updated preliminary model, pᵢ denotes a predicted probability that the voxel i belongs to the sample ROI according to the predicted 3D segmentation image, gᵢ denotes a probability that the voxel i belongs to the sample ROI according to the ground truth 3D segmentation image, and N denotes a count of voxels in the predicted 3D segmentation image.

If the termination condition is not satisfied in the current iteration, the processing device 140B may further update the updated preliminary model to be used in a next iteration according to, for example, a backpropagation algorithm. If the termination condition is satisfied in the current iteration, the processing device 140B may designate the updated preliminary model in the current iteration as the ROI segmentation model.

In some embodiments, the processing device 140B may determine at least one learning rate for training the preliminary model. Merely by way of example, the processing device 140B may determine a plurality of learning rates. For each learning rate, the processing device 140B may perform a certain count of iterations to update the preliminary model according to the learning rate, and record the change in the loss function in the iterations. The processing device 140B may determine a learning rate range based on the changes in the loss function corresponding to different learning rates. For example, if the loss function corresponding to a learning rate is basically unchanged, the learning rate may be determined as a minimum value of the learning rate range. If the loss function corresponding to a learning rate is divergent, the learning rate may be determined as a maximum value of the learning rate range. If the change speed of the loss function corresponding to a learning rate is fastest, the learning rate may be determined as an initial learning rate. The training of the preliminary model may then be performed based on one or more learning rates in the learning rate range using an Adam optimizer. For example, the learning rate of the preliminary model may be equal to the initial learning rate at the start of the training process, and vary in the learning rate range during the training process. In some embodiments, the processing device 140B may adopt an early stopping strategy in the training process, which may avoid overfitting and improve the generalization performance of the ROI segmentation model.

FIG. 11A is a schematic diagram illustrating an exemplary preliminary model 1100A according to some embodiments of the present disclosure. As shown in FIG. 11A, the preliminary model 1100A to be trained is a V-net model. The preliminary model 1100A may include multiple residual blocks 1110 (e.g., 1110A, denoted as circles in FIG. 11A) multiple convolution blocks 1120 (denoted as down arrows in FIG. 11A), multiple deconvolution blocks 1130 (denoted as up arrows in FIG. 11A), a convolution block 1140, and a softmax activation function 1150.

A sample 3D image 1102 may be inputted into the preliminary model 1100A. A residual block 1110 may be configured to perform, such as, one or more convolution operations, one or more nonlinear transformations, etc., on its input. The residual block 1110 may have a same configuration as or a similar configuration to a residual block 1100B as described in connection with FIG. 11B. A convolution block 1120 may be configured to perform a down-sampling operation on its input. For example, the convolution block 1120 may perform one or more convolution operations using one or more 2*2 kernels with a stride 2. In some embodiments, the resolution of the output of a convolution block 1120 may be lower than that of the input of the convolution block 1120.

A deconvolution block 1130 may be configured to perform an up-sampling operation on its input. For example, the deconvolution block may perform one or more deconvolution operations using one or more 2*2 kernels with a stride 2. In some embodiments, the resolution of the output of a deconvolution block 1130 may be higher than that of the input of the deconvolution block 1130.

In some embodiments, a residual block in the left path of the preliminary model 1100A may be connected to a corresponding residual block in the right path of the preliminary model 1100A via a skip connection, wherein the two corresponding residual blocks may process feature maps having a same image resolution and located at same layer. The residual block in the left path of the preliminary model 1100A may forward its output to its corresponding residual block in the right path via the skip-connection (or referred to as feature forwarding at a fine grit). The utilization of the skip connection may prevent gradient vanishing, improve the convergence speed of the preliminary model 1100A during model training, and improve the accuracy of the ROI segmentation model trained from the preliminary model 1100A.

The convolution block 1140 may receive an output from the residual block 1110A as an input. The convolution block 1140 may be configured to perform one or more convolution operations by one or more 1*1*1 kernels and output a probability map. The probability map may include one or more probability values of the voxels of the sample 3D image 1102, wherein a probability value of a voxel may indicate a probability that the voxel belongs to a certain classification (e.g., a background voxel, the ROI, etc.). In some embodiments, the convolution block 1140 may be also referred to as an output block of the preliminary model 1100A.

The softmax activation function 1150 may generate a segmentation result 1104 (e.g., a predicted 3D segmentation image) based on the probability map outputted by the convolution block 1140. For example, the preliminary model 1100A may be used to segment the heart of a sample subject from the sample 3D image 1102. The softmax activation function 1150 may segment voxels corresponding to the heart from the sample 3D image 1102, wherein the probability value that each segmented voxel belongs to the heart is greater than a threshold value.

FIG. 11B is a schematic diagram illustrating an exemplary residual block according to some embodiments of the present disclosure. As illustrated in FIG. 11B, the residual block 1100B may include a plurality of convolutional layers (e.g., 1160-1, 1160-2, and 1160-3), a plurality of rectified linear unit (ReLU) layers (e.g., 1170-1, 1170-2, and 1170-3). Each of the plurality of convolutional layers may be configured to perform one or more convolution operations by, for example, one or more 5*5*5 kernels with a stride 1. Each of the plurality of ReLU layers may be configured to perform a nonlinear transformation. In some embodiments, an input x (e.g., a feature map received from a convolution block) may be inputted into the residual block 1100B. The convolutional layers and the ReLU layers may process the input x and generate an output F(x). The original input x and the output F(x) may be added together to generate an output of the residual block 1100B. In some embodiments, the size of an output of the residual block 1110B may be the same as that of the input of the residual block 1100B.

It should be noted that the examples illustrated in FIGS. 11A and 11B and the above descriptions thereof are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the preliminary model 1100A may include one or more additional components (e.g., additional convolution block(s), additional residual block(s), and/or additional deconvolution block(s)). Additionally or alternatively, one or more components of the preliminary model 1100A (e.g., a skip-connection) may be omitted. In addition, a parameter value (e.g., the count of layers, the stride of a convolution block) of the preliminary model 1100A and the residual block 1100B provided above may be illustrative and can be modified according to actual needs.

It will be apparent to those skilled in the art that various changes and modifications can be made in the present disclosure without departing from the spirit and scope of the disclosure. In this manner, the present disclosure may be intended to include such modifications and variations if the modifications and variations of the present disclosure are within the scope of the appended claims and the equivalents thereof.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate a certain variation (e.g., ±1%, ±5%, ±10%, or ±20%) of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable. In some embodiments, a classification condition used in classification or determination is provided for illustration purposes and modified according to different situations. For example, a classification condition that “a value is greater than the threshold value” may further include or exclude a condition that “the probability value is equal to the threshold value.”

What is claimed is:

1. A system for image processing, comprising:
at least one storage device including a set of instructions; and
at least one processor configured to communicate with the at least one storage device, wherein when executing the set of instructions, the at least one processor is configured to direct the system to perform operations including:
obtaining a three-dimensional (3D) image of a subject;
obtaining a region of interest (ROI) within the subject;
generating a 3D segmentation image relating to the ROI of the subject based on the 3D image;
selecting, from the 3D image, a multi-planar reconstruction (MPR) plane; and
determining, based on the 3D image and the 3D segmentation image, a target 2D image of the MPR plane, wherein the target 2D image of the MPR plane includes a bounding box annotating the ROI on the MPR plane.

2. The system of claim 1, wherein the selecting, from the 3D image, an MPR plane comprises:
determining, from the 3D image, a central point and a normal vector of the MPR plane; and
determining, based on the central point and the normal vector of the MPR plane, the MPR plane.

3. The system of claim 1, wherein the determining, based on the 3D image and 3D segmentation image, a target 2D image of the MPR plane comprises:
determining, based on the 3D image, an initial 2D image of the MPR plane, the initial 2D image including a pixel value of each physical point on the MPR plane;
determining, based on the 3D segmentation image, position information of the bounding box; and
generating, based on the initial 2D image and the position information of the bounding box, the target 2D image of the MPR plane.

4. The system of claim 3, wherein the determining, based on the 3D image, an initial 2D image of the MPR plane comprises:
for each physical point on the MPR plane,
identifying, from the 3D image, a first voxel corresponding to the physical point; and
determining, based on the 3D image and the first voxel, a first pixel value of the physical point; and
generating, based on the first pixel value of each physical point, the initial 2D image.

5. The system of claim 3, wherein determining, based on the 3D segmentation image, position information of the bounding box comprises:
determining, based on the 3D segmentation image and the MPR plane, a 2D segmentation image of the ROI corresponding to the MPR plane; and
determining, based on the 2D segmentation image, the position information of the bounding box of the ROI.

6. The system of claim 5, wherein the determining, based on the 3D segmentation image and the MPR plane, a 2D segmentation image of the ROI corresponding to the MPR plane comprises:
for each physical point on the MPR plane,
identifying, from the 3D segmentation image, a second voxel corresponding to the physical point; and
determining, based on the 3D segmentation image and the second voxel, a second pixel value of the physical point; and
generating, based on the second pixel value of each physical point, the 2D segmentation image.

7. The system of claim 5, wherein the MPR plane corresponds to a coordinate system including a first coordinate axis and a second coordinate axis, and
the determining, based on the 2D segmentation image, the position information of the bounding box of the ROI comprises:
determining, based on the 2D segmentation image, a first maximum value and a first minimum value of the ROI on the first coordinate axis;
determining, based on the 2D segmentation image, a second maximum value and a second minimum value of the ROI on the second coordinate axis; and
determining the position information of the bounding box based on the first maximum value, the first minimum value, the second maximum value, and the second minimum value.

8. The system of claim 1, wherein the ROI includes multiple sub-ROIs, and the at least one processor is further configured to direct the system to perform the operations including:
selecting, from the multiple sub-ROIs, one or more target sub-ROIs, wherein the bounding box annotates the one or more target sub-ROIs on the MPR plane.

9. The system of claim 1, wherein the generating a 3D segmentation image relating to the ROI of the subject based on the 3D image comprises:
generating the 3D segmentation image by processing the 3D image using an ROI segmentation model.

10. The system of claim 9, wherein the ROI segmentation model is trained according to a training process including:
obtaining at least one training sample each of which includes a sample 3D image of a sample subject and a ground truth 3D segmentation image of a sample ROI of the sample subject; and
generating the ROI segmentation model by training a preliminary model using the at least one training sample.

11. The system of claim 10, wherein the obtaining at least one training sample comprises:
obtaining at least one initial training sample; and
generating the at least one training sample by preprocessing the at least one initial training sample.

12. A method for image processing implemented on a computing device having at least one processor and at least one storage device, the method comprising:
obtaining a three-dimensional (3D) image of a subject;
obtaining a region of interest (ROI) within the subject;
generating a 3D segmentation image relating to the ROI of the subject based on the 3D image;
selecting, from the 3D image, a multi-planar reconstruction (MPR) plane; and
determining, based on the 3D image and the 3D segmentation image, a target 2D image of the MPR plane, wherein the target 2D image of the MPR plane includes a bounding box annotating the ROI on the MPR plane.

13. The method of claim 12, wherein the selecting, from the 3D image, an MPR plane comprises:
determining, from the 3D image, a central point and a normal vector of the MPR plane; and
determining, based on the central point and the normal vector of the MPR plane, the MPR plane.

14. The method of claim 12, wherein the determining, based on the 3D image and 3D segmentation image, a target 2D image of the MPR plane comprises:
determining, based on the 3D image, an initial 2D image of the MPR plane, the initial 2D image including a pixel value of each physical point on the MPR plane;
determining, based on the 3D segmentation image, position information of the bounding box; and
generating, based on the initial 2D image and the position information of the bounding box, the target 2D image of the MPR plane.

15. The method of claim 14, wherein the determining, based on the 3D image, an initial 2D image of the MPR plane comprises:
for each physical point on the MPR plane,
identifying, from the 3D image, a first voxel corresponding to the physical point; and
determining, based on the 3D image and the first voxel, a first pixel value of the physical point; and
generating, based on the first pixel value of each physical point, the initial 2D image.

16. The method of claim 14, wherein determining, based on the 3D segmentation image, position information of the bounding box comprises:
determining, based on the 3D segmentation image and the MPR plane, a 2D segmentation image of the ROI corresponding to the MPR plane; and
determining, based on the 2D segmentation image, the position information of the bounding box of the ROI.

17. The method of claim 16, wherein the determining, based on the 3D segmentation image and the MPR plane, a 2D segmentation image of the ROI corresponding to the MPR plane comprises:
for each physical point on the MPR plane,
identifying, from the 3D segmentation image, a second voxel corresponding to the physical point; and
determining, based on the 3D segmentation image and the second voxel, a second pixel value of the physical point; and
generating, based on the second pixel value of each physical point, the 2D segmentation image.

18. The method of claim 16, wherein the MPR plane corresponds to a coordinate system including a first coordinate axis and a second coordinate axis, and
the determining, based on the 2D segmentation image, the position information of the bounding box of the ROI comprises:
determining, based on the 2D segmentation image, a first maximum value and a first minimum value of the ROI on the first coordinate axis;
determining, based on the 2D segmentation image, a second maximum value and a second minimum value of the ROI on the second coordinate axis; and
determining the position information of the bounding box based on the first maximum value, the first minimum value, the second maximum value, and the second minimum value.

19. The method of claim 12, wherein the ROI includes multiple sub-ROIs, and the at least one processor is further configured to direct the system to perform the operations including:
selecting, from the multiple sub-ROIs, one or more target sub-ROIs, wherein the bounding box annotates the one or more target sub-ROIs on the MPR plane.

20. A non-transitory computer readable medium, comprising a set of instructions for image processing, wherein when executed by at least one processor of a computing device, the set of instructions direct the computing device to perform a method, the method comprising:
obtaining a three-dimensional (3D) image of a subject;
obtaining a region of interest (ROI) within the subject;
generating a 3D segmentation image relating to the ROI of the subject based on the 3D image;
selecting, from the 3D image, a multi-planar reconstruction (MPR) plane; and
determining, based on the 3D image and the 3D segmentation image, a target 2D image of the MPR plane, wherein the target 2D image of the MPR plane includes a bounding box annotating the ROI on the MPR plane.
